(19) United States
(12) Patent Application Publication
(10) Pub. No.: US 2007/0291265 A1
(43) Pub. Date: Dec. 20, 2007

(54) OPTICAL APPARATUS FOR SIMULTANEOUSLY MEASURING THE SCATTERING AND CONCENTRATION OF SIGNALS OF MACROMOLECULES IN A FLOW CELL

(75) Inventors: Steven Holman, Starkville, MS (US); Bin Guo, Charlotte, NC (US); W. William Wilson, Starkville, MS (US); Joseph C. Fanguy, Starkville, MS (US)

Correspondence Address: BUTLER, SNOW, O'MARA, STEVENS & CANNADA PLLC, 6075 POPLAR AVENUE, SUITE 500, MEMPHIS, TN, 38119, US

(73) Assignee: MISSISSIPPI STATE UNIVERSITY, Mississippi State, MS (US)

(21) Appl. No.: 11/735,206

(22) Filed: Apr. 13, 2007

Related U.S. Application Data
(60) Provisional application No. 60/744,770, filed on Apr. 13, 2006.

(51) Int. Cl. G01J 3/42; G06F 19/00

(52) U.S. Cl. 356/320; 702/22

(57) ABSTRACT

This invention relates to a fiber optic apparatus for simultaneously measuring the scattering and concentration signals of macromolecules in a flow cell 3. The apparatus is based on the delivery/focusing of both a laser and ultraviolet light source to the same physical position in a low volume flow cell 4, via a bifurcated optical fiber 3. This configuration allows the light scattering and concentration signal changes associated with a macromolecular solution passing through the flow channel to be measured simultaneously. This invention also relates to a method that uses the optical apparatus 10 to determine properties of a macromolecular solution such as the ideal crystallization and/or formulation conditions (via B₂₂) for a given protein solution.

### CROSS REFERENCE RELATED TO PATENT APPLICATION

This Application claims the benefit of U.S. Ser. No. 60/744,770 filed Apr. 13, 2006 under 35 U.S.C. § 1.119(e) (hereby specifically incorporated by reference in its entirety)

### STATEMENT REGARDING FEDERALLY SPONSORED RESEARCH SUPPORT & DEVELOPIMENT

This invention. was made with Government support under Disclosure #06-0201-208, NAG8-1837 awarded by NASA. The Government has certain rights in the invention

### BACKGROUND OF THE INVENTION

This invention relates to an optical apparatus 10 for simultaneously measuring the scattering and concentration signals of macromolecules in a flow cell, and a method using the apparatus to determine ideal protein crystallization and formulation conditions via the osmotic second virial coefficient.

The molecular weight distribution of a macromolecular solution, such as a biopolymer, can be estimated via chemical separation according, to particle size followed by a measurement of the light scattering and concentration signals associated with the eluting peaks. This type of measurement has been accomplished traditionally via sequential detection schemes. in which the light scattering, and concentration signals related to the eluting sample plug are measured at slightly different physical positions, as well as points in time. Although seemingly straightforward, this approach requires utilization of mathematical correction formulas aimed at estimating the amount of diffusion and mixing that occurs between the first and second points of detection. This approach is widely used, however, errors are often associated with the inter-detector band broadening and inter-detector delay volume estimates. Therefore, a simultaneous measurement of the concentration and light scattering signals of an eluting sample plug would provide a means to more accurately determine molecular weight distributions. In addition, this simultaneous measurement approach would provide a more efficient means by which other macromolecular parameters, such as the osmotic second virial coefficient (B₂₂), could be determined.

The osmotic second virial coefficient has been recognized as a dilute solution parameter by which the processes for (1) developing therapeutic pharmaceutical molecules and (2) identifying ideal pharmaceutical formulations could be greatly improved. Structure based drug design, which is based on the three-dimensional structure of a protein, provides chemists with an ideal template to understand the process of interaction between a potential therapeutic molecule and the target protein. Although x-ray diffraction is the primary method for determining the three-dimensional structure of proteins with pharmaceutical implication, the technique is underutilized, as a diffractive quality protein crystal is required for x-ray analysis. Growth of a diffracting, quality crystal is dependent upon the formation of an ordered aggregate of protein molecules in solution, of which minute differences in the conditions can have a major influence on the aggregation process. The large number of possible solution. conditions that can result from varying combinations of buffer type, pH, temperature, protein concentration, and the type and concentration of any buffer additive therefore creates a bottleneck in the structure-based drug design process.

Once a pharmaceutical molecule, has been identified for the treatment of a condition or disease, the same aforementioned solution conditions must be screened in an effort to find combinations that stabilize the molecule in solution. The success of these efforts to prevent the aggregation process and maintain the physical stability of these solutions is extremely important, as the developed therapeutic formulation must maintain an economically viable shelf life for appropriate distribution and use. Both minor adjustments in the solution chemistry as well as additives including amino acids, sugars, polyols, and/or polymers are typically studied as a means to minimize both the physical and chemical degradation of the protein solution. Therefore, as with protein crystallization trials. the large number of solution conditions that must be considered during the optimization process greatly blurs any obvious path toward the development of an ideal pharmaceutical formulation.

The osmotic second virial coefficient is an ideal alternative to traditional pharmaceutical trial and error methods, as B₂₂ is an experimentally determined parameter that quantifies the fundamental physical interactions that exist between protein molecules in different solution conditions. Conditions that promote net attractive forces between protein molecules will result in protein aggregation and subsequently crystallization or precipitation in solution. Alternatively, physically stable (no aggregation) protein solutions will result under conditions that promote net repulsion between the protein molecules in a given solution. Chi, E. Y. et at.; 12 Protein Science, 903-913, (2003). demonstrated a correlation between- the magnitude of B₂₂ and aggregation rates of granulocyte colony-stimulating factor (G-CSF ) with more positive B₂₂ values being associated with slower aggregation rates as a result of more repulsive protein interactions. In addition, a strong, correlation between B₂₂ and protein crystallization has been well established. George, A.; et al., W. W. Acta Cyrstallographica. Section D, 50, Biological Crystallography, 361-365 (1994) presented a range of B₂₂ values that identified solution conditions ideal for growing protein crystals. This “crystallization slot” represents protein-protein interactions that are slightly to moderately attractive, with the corresponding conditions resulting in an ordered aggregation process.

Although predictive screening efforts based on B₂₂ seem like an ideal alternative to the traditionally employed trial and error approach, extensive application of the parameter, has been limited by the demands of the experimental methodologies used to measure B₂₂. Osmotic pressure and sedimentation equilibrium are time consuming and require large amounts of protein to perform a single measurement. Another traditional approach, batch mode static light scattering (BM/SLS), has been shown to be more experimentally friendly than the aforementioned techniques, however the need. to perform multiple concentration and light scattering measurements per solvent condition limits its potential.

Decreased sample requirements (per analysis) and improvements toward high-throughput experimental methodology have been demonstrated with both self interaction chromatography (SIC), Tessier Peter, et at., I. 82, Biophysical Journal, 1620-1631, (2002) and Tessier Peter, M. et al.; Bryan, W. et al., M. 58, Acta Crystallographica. Section D, Biological Crystallography, 1531-1535 (2002) and size exclusion chromatography (SEC), Bloustine, J. et al., S. 85, Biophysical Journal, 7104 261.9-2623 (2003). However, additional complications exist for each of these procedures. SIC requires the protein of interest to be immobilized on an appropriate substrate before a particular solvent condition can be evaluated. This not only lengthens the setup period for experimentation, but also complicates the development process as different immobilization strategies must be considered for different types of proteins. Although measuring B₂₂, using SEC is straightforward experimentally, errors are commonly linked to the sequential detection schemes for which inter-detector band broadening and the inter-detector delay volume must be corrected.

Most recently, Bajaj, H. et al.; 87,Biophysical Journal, 4048-4055, (2004) presented a method for determining B₂₂ via the simultaneous measurement of a static light scattering and transmittance (concentration) signal for a flowing protein solution. The dual-detector flow cell was shown to be reliable for determining B₂₂ of several. well understood protein/solvent conditions. However, the milligram quantities of protein required per analysis of each solvent condition illustrated the limited applicability of this specific technique for a high-throughput analysis system, where microgram or even nanogram quantities of protein (per analysis) are desirable. In addition, the experimental design of the flow cell required the two light sources to probe different regions of the flow cell. This approach did not guarantee a true “simultaneous” analysis, as the exact same region of the eluting sample plug was not measured by both detection strategies.

### BRIEF SUMMARY OF THE INVENTION

This invention relates to a fiber optic apparatus for simultaneously measuring the scattering and concentration signals of macromolecules in a flow cell. The apparatus is based on focusing of electromagnetic radiation light sources to the same physical position in a low volume flow cell, via a bifurcated optical fiber. This configuration allows the light scattering and concentration signal changes associated with a macromolecular solution passing through the flow channel to be measured simultaneously. This invention also relates to a method that uses the optical apparatus 10 to determine the properties of a macromolecular solution such. as ideal crystallization and/or formulation conditions (via B₂₂) for a given. protein solution. This invention solves the problem of determining the macromolecular solution properties of a flowing, macromolecular solution by simultaneously measuring the light scattering and concentration of the solution.

### BRIEF DESCRIPTION OF SEVERAL VIEWS OF THE DRAWINGS

A more complete appreciation of the present invention and many attendant advantages thereof will be readily understood by reference to the following, detailed description of the invention when considered in connection with the accompanying drawings, wherein:

FIG. 1. is a schematic representation of the optical apparatus 10 experimental approach where laser source 1, ultraviolet source 2, scattering detector 30, concentration detector 31, flow cell 4, and bifurcated optical fiber 3. The dashed line represents the light emitted from the bifurcated fiber (thick black line), as well as that measured by both detectors.

FIG. 2. is a schematic of the optical apparatus 10 with as the fiber optic coupler 23, as the adjustable collimating lens 24, as the telescoping lens 25, as the objective lens 27, as the 280 nm bandpass filter 28, and as the bifurcated optical fiber 3 assembly.

FIG. 3. is a typical Debye plot where the four data points correspond to light scattering/concentration pairs for which linear re(2regression gives a second virial coefficient of −5.2×10⁻⁴ mol mL g⁻².

FIG. 4 is an example chromatogram overlay to illustrate the concept of the optical apparatus 10 methodology. The solid black line represents the concentration trace while the dotted line represents the light scattering trace. Each of the numbered (shaded) intervals represents a time/data point along the profile.

FIG. 5. is a schematic of the assembled flow injection analysis system used with the optical apparatus 10.

FIG. 6. is a time scan of eluting 5 μL injection (6 mg/mL) of lysozyme at 1 μl/min, as detected by the optical apparatus 10.

FIG. 7. is a debye plots for 0, 2, and 5% (w/v) NaCl solutions with the corresponding B₂₂ values determined by matching the appropriate concentration and intensity values from the tailing edge of the eluting sample plug.

FIG. 8. is a time scan of ESA in solvent #3, which contained 11% (w/v) PEG, 6% (w/v) glycerol, 0.01 M MgCl₂, and 0.05 M Arginine.

FIG. 9. is a debye plot for ESA in solvent #3, as evaluated with the optical apparatus 10.

### DETAILED DESCRIPTION OF THE INVENTION

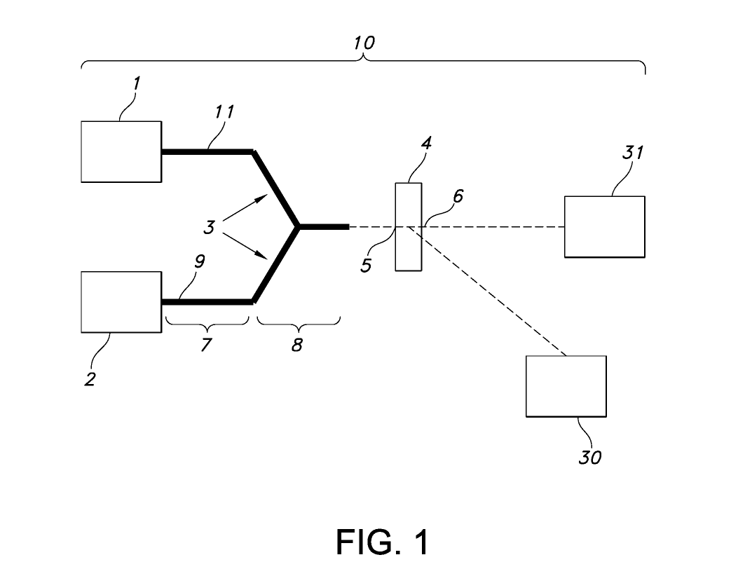

Now referring to FIG. 1, an optical apparatus 10 provides a more straightforward and efficient (protein mass requirement) means to simultaneously measure the lit scattering and concentration of a macromolecular solution. A macromolecular solution is a solution of a very large molecule, as a colloidal, particle. protein, or polymer composed hundreds or thousands of atoms. More specifically the macromolecular solution is a biopolymer or a polymer monomer. The sample can be monodispersed on a polydispersed sample.

The simultaneous detection approach presented here, is the combination of a bifurcated optical fiber 3 and a low volume flow cell 4, (total volume of actual cell was 1.3 μL—“low volume” range would be less than 5 μL). The channel of a quartz cytometry cell (Hellima, Plainview, N.Y.) served as the flow path of buffer/sample solutions for the scattering/absorption experiments. The rectangular cell was 4.2×4.2×20.3 mm with a 0.25×0.25 mm channel that extended through the middle of the entire length (20.3 mm) of the cell. This small inner diameter channel design (total volume of 1.3 μL) was ideal for low volume injections. Delivery of both a first source of electromagnetic radiation 1 such as the laser and a second source of electromagnetic radiation 2 such as ultraviolet light to the same point in the flow cell 4 permits the determination of B₂₂ by pairing the detected light scattering, and concentration signals respectively measured by the scattering 30 and concentration detectors 31. Additionally, a small diameter detection flow cell 4 permits an online analysis to be performed using only microliters of protein sample per solvent. The optical apparatus 10 can be used to screen a series of potential crystallization solvents for equine serum albumin, as well as to evaluate the B₂₂ constant as a predictor of solubility (protein formulation identification).

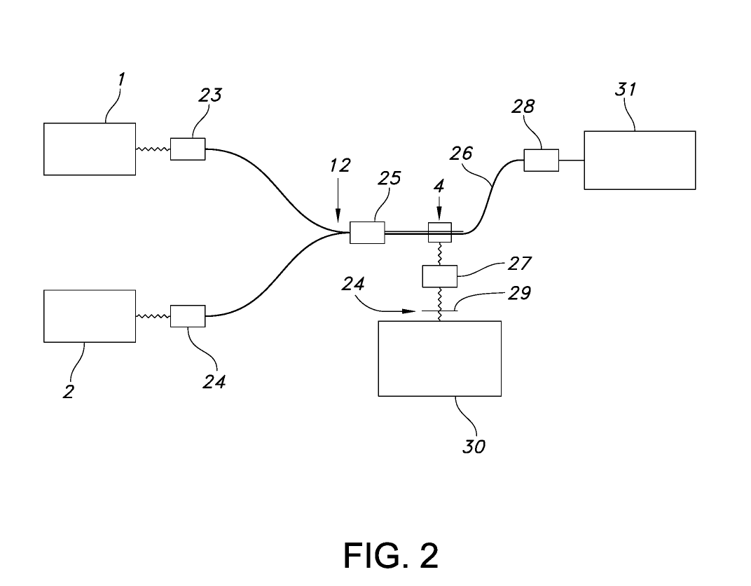

Now referring to FIGS. 1 and 2, a schematic representation of the optical apparatus 10 is shown. This optical apparatus 10 includes a flow cell 4 having an at least one inlet 5 and at least one outlet 6. A first source of electromagnetic radiation 1 is a laser source, in this embodiment; however, it can be ultraviolet, ultraviolet-visible, infrared, visible, or near infrared lamps. A second source of electromagnetic radiation 2 is an ultraviolet source in this embodiment; however, it can be infrared, visible, or near infrared lamps. A bifurcated optical fiber 3 has a first end 7. The first end 7 includes a first arm 9 and second arm 11 with the first arm 9 optically coupled to the first source of electromagnetic radiation 1 and the second arm 11 optically coupled to the second source of electromagnetic radiation 2. The bifurcated optical fiber 3 also includes a second end 8 which transmits the electromagnetic radiation from both the first and second sources into the flow cell 4 to produce a concentration signal and a light scattering signal. In one embodiment, the first arm 9 is made of silica and the second arm 11 is made of quartz. A bifurcated optical fiber 3 is optically coupled to the first source of electromagnetic radiation 1 and the flow cell 4. The bifurcated optical fiber 3 can be single mode, multimode or combination thereof.

The flow cell 4 produces a concentration signal and a light scattering, signal. The apparatus 10 provides a means for measuring the concentration signal such as ultraviolet detection 31. The means for measuring the concentration signal can be ultraviolet, ultraviolet-visible, infrared, visible and near infrared detector. Additionally, at least one means for measuring the light scattering signal is provided such as a light scattering detection 30. The means for measuring the light scattering can be ultraviolet, ultraviolet-visible, infrared visible and near infrared detectors.

The optical apparatus 10 also provides a computing means for calculating the macromolecular solution properties from the concentration. signal and the light scattering signal. The output of both the laser scattering 30 and ultraviolet detectors 31 was in the form of a 0-10 V DC signal. Therefore, simultaneous acquisition of these signals was accomplished using a National Instruments 12-bit PCI-6024E board, which. featured 16 channels of analog input. After installation of the board into the 5 V PCI slot on a Gateway E-4200 computer, each of the detector output leads were properly attached to the 68-pin input/output connector. A LabView based program was written to read the data acquisition board, process the signal, and then output the data in a spreadsheet format. A data acquisition rate of 1 sample/second was nominally utilized for all examples.

More specifically, optical apparatus 10 having a bifurcated optical fiber 3 of which two fiber legs were respectively coupled to a 532 nm laser diode and an ultraviolet light source tuned to 280 nm was developed. For optimal transmission, a high-OH optical fiber was utilized as the leg for the ultraviolet source, while the laser source was coupled to an ultra-low-OH fiber. Both fibers were step-index multimode made of a pure fused silica core with a numerical aperture of 0.22. The common end 12 of the assembly thereby emitted light at both 532 nm (for light scattering) and 280 nm (for transmittance). Maximum coupling efficiency of the light sources into the respective fiber legs was accomplished using a fiber optic coupler 23 for the laser light and an adjustable collimating lens 24 for the ultraviolet radiation. In addition, a focusing lens 25 was placed in line with the second end 8 of the bifurcated optical fiber 3 in order to focus the two diverging light beams inside the 0.250 mm cross section channel of a flow cell 4.

Static light scattering measurements were made at a 90° angle to the laser beam, with additional optics utilized to isolate the true solution scattering signal from several potential sources of stray light (room, reflections, etc . . . ). First, an adjustable circular aperture was mounted away from the detection cell to limit the field of view of the objective lens 27 that was positioned directly behind the aperture. The scattering light signal thereby reaching the lens 27 was expanded and focused on a pinhole 29. The focused image contained two regions of light: 1) the scattering signal from the interaction of the laser light with the solution and 2) bright spots (on the outer edges of the image) due to the refractive index difference between the glass surrounding the channel and the solution in the channel. The pinhole 29 was therefore positioned at the focal point of the image to only allow the true solution scattering signal to reach the solid state detector 30, which was mounted behind the pinhole 29. Single mode optical fibers may also be used to collect the light scattering signal. Transmittance signals were measured by mounting a quartz collection fiber (single mode or multimode) on the side of the cell opposite the common fiber for collection of UV light. This collection fiber 26 terminated at the head of a photodiode which utilized a 280 nm bandpass filter 28 to filter out the incident laser light (532 nm) and permit accurate determination of the solution concentration (so as to isolate the concentration signal for the stray electromagnetic radiation). The output of both the laser scattering detector 30 and ultraviolet detectors 31 was recorded on a personal computer (not shown), from which appropriate data analysis could be performed.

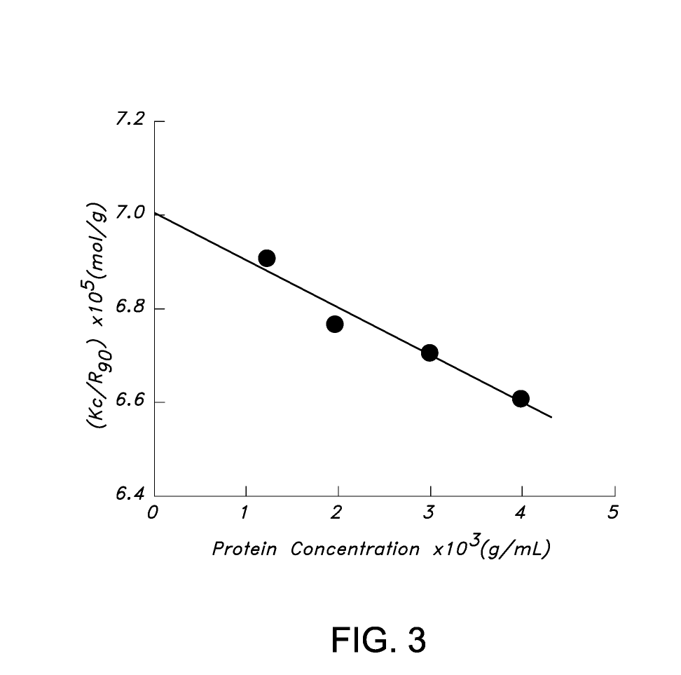

In one embodiment of the invention, the optical apparatus 10 is utilized to identify whether a protein solvent is an ideal solution condition for crystallizing or stabilizing the protein of interest. This method was based upon a batch mode static light scattering (BM/SLS) experiment, which requires a measurement of the scattered light intensity (in excess of background) from a protein solution as a function of protein concentration. The static light scattering intensity of a given protein solution is expected to be independent of the scattering angle, as the molecular size of the particles under study does not exceed 1/ 20^{th} the incident wavelength. This lack of angular dependence thereby allows utilization of the static light scattering, intensities of four to eight dilutions of a stock protein solution (of known concentration) to obtain a series of data points that are cast according to the working equation
Kc/R₉₀=1/M+2B₂₂c (1-1)
where K is an optical constant given by
K=4π(dn/dc)²nₒ²/N_{A}λ⁴ (1-2)
c is the protein concentration (g cm⁻³), M is the molecular weight of the protein (g mol⁻¹), B₂₂ is the second virial coefficient (slope/(y-intercept×2M) (mol mL g⁻²), no is the solvent refractive index, N_{A} is Avogadro's number (mol⁻¹), dn/dc is the refractive index increment (cm³ g⁻¹), λ is the wavelength (cm) of the incident light in a vacuum, and R₉₀ is the excess Rayleigh ratio (cm⁻¹) at a 90° angle, defined by
R₉₀=(P₉₀/Pᵢ)*(ΔΩ*l)⁻¹ (1-3)
where P₉₀ is the radiant power of the light collected at 90° (W m⁻² nm⁻¹), Pᵢ is the radiant power of the incident beam (W m⁻² nm⁻¹), ΔΩ is the solid angle of the scattered light collected, and l is the length of the scattering volume (cm). The resulting Kc/R₉₀ vs. c relationship (Debye plot) is linear, and therefore the y-intercept and slope can be used respectively to determine the molecular weight and the second virial coefficient of the evaluated protein. A sample Debye plot for lysozyme in a 0.1 M NaAc solution (pH: 4.2) with 5% (w/v) added NaCl is shown in FIG. 3 for which each point represents a measured light scattering/concentration pair that collectively define the Debye regression (B₂₂=−5.1×10⁻⁴ mol mL g⁻².

An alternative method for determining B₂₂ utilizes a plot of protein concentration/baseline subtracted intensity (c/l) vs. concentration (c). The resulting linear relationship is similar to that of a Kc/R₉₀ vs. c plot, where c/l can be related to Kc/R₉₀ via a proportionality constant A,
Kc/R₉₀=A(c/l). (1-4)
Since
lim (c→0) Kc/R₉₀=l/M, (1-5)
substituting Equation 1-4 into Equation 1-5 and solving for the proportionality constant gives
A=(l/M)/lim (c→0)(c/I) (1-6)
where lim (c→0) c/I is the y-intercept of the c/I vs. c plot and M is fixed for a given protein. Substituting, Equation 1-4 into Equation 1-1 and the solving for c/I gives
c/I=l/(A*M)+2/A*B₂₂c (1-7)
which allows the slope and intercept of the c/I vs, c plot to be identified as
Slope=2B₂₂/A (1-8)
and
Intercept=l/(AM) (1-9)
Finally, solving Equation 1-8 for B₂₂ and using. the intercept to determine the proportionality constant gives
B₂₂=A slope/2=slope/(y-intercept*2M)*1000. (1-10)
where 1000 is a volume conversion factor for final units of mol mL g⁻².

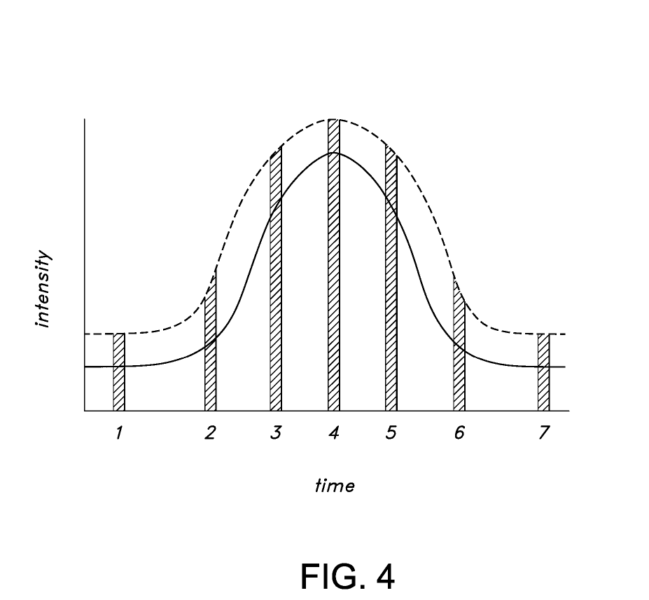

The invention described herein provides a platform by which the same concentration and light scattering data. pairs can be obtained by utilizing individual points along simultaneously obtained light scatttering( and concentration chromatographic peak profiles that correspond to a volume of protein solution flowing through a detection cell. The concept can be understood by considering the chromatographic profiles illustrated in FIG. 4. Along both the leading and tailing edges of the concentration profile. specific regions (shaded) represent different concentrations that extend from zero at the baseline (t=1 or 7) up to some maximum concentration (t=4). Therefore, by measuring these concentration values online and pairing them with the corresponding values along the light scattering profile, the data point pairings needed to construct a Debye plot can be obtained from a single injection of a protein solution of unknown concentration. Novel to the simultaneous detection approach presented here is the combination of a bifurcated optical fiber 3 and a low volume flow cell 4. Delivery of both the laser and ultraviolet light 2 to the same point in the flow cell 4 permits the online determination of B₂₂ by pairing the detected light scattering and concentration signals respectively measured by the scattering using a laser scattering detector and concentration detectors 31. Additionally, a small diameter flow cell 4 permits the online improved method of determining B22 to be performed using only microliters of protein sample per solvent condition evaluated. The optical apparatus 10 was used to screen a series of potential crystallization solvents for equine serum albumin, as well as to evaluate the B₂₂ as a predictor of solutbility, which is related to protein formulation studies.

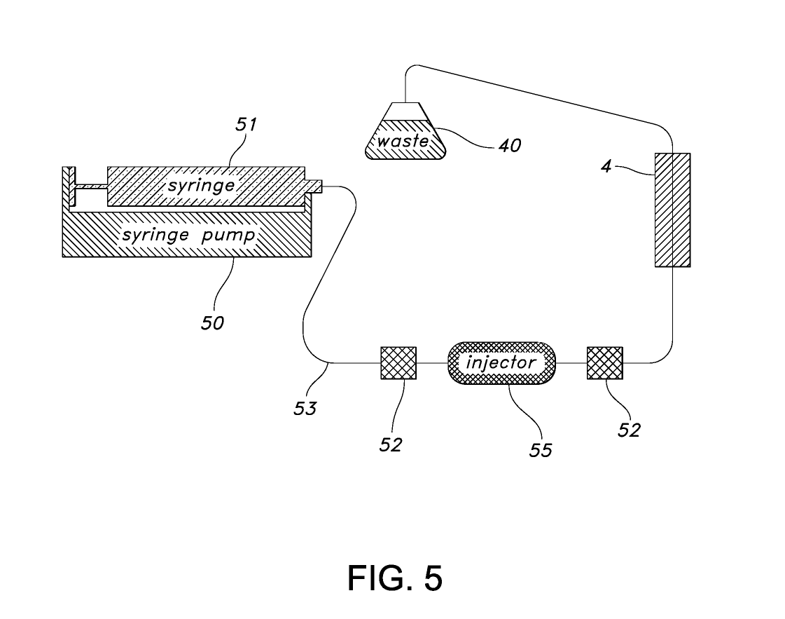

The procedure by which a macromolecular solution is evaluated required a flow injection analysis setup to be constructed around the flow cell 4. The complete flow injection analysis setup is illustrated in FIG. 5. This is a sample delivery system for introducing a macromolecular solution into the flow cell 4. A syringe pump 50 and corresponding syringe 51 were used to supply a constant stream of buffer throughout the flow injection analysis system. In series with the pump was an injection valve 55 which permitted reproducible injections of protein solution into the flowing buffer stream. hi addition, filters 52 were positioned both before and after the injector 57 to remove any particulates that would distort the static light scattering signal. All connections between the components were accomplished with sections of tubing 53 (Such as PEEK). With an appropriate buffer solution flowing through the entire flow injection analysis setup, samples were injected into the flowing stream via the injector, upon which the appropriate light scattering and concentration measurements were made. The sample passed through to flow cell 4 to waste 60.

### EXAMPLE 1

Solutions and sample preparation. A 0.1 M acetic acid/sodium acetate buffer containing 2% (w/v) sodium chloride was prepared by dissolving 6.0 g of glacial acetic acid and 20 (g of sodium. chloride in approximately 900 ml of distilled/deionized water (Milli-Q Academnc, Billerica, Mass.). This solution was titrated to a pH of 4.2 using 1 M NaOH and then diluted to 1000 mL with distilled/deionized water. The 0.1 M acetic acid/sodium acetate buffer containing 5%/ (w/v) sodium chloride was prepared in the very same manner with the exception that 50 g of sodium chloride was dissolved in solution. For lysozyme sample preparation, hen egg white lysozyme (6×crystallized) was slowly dissolved into the appropriate 0.1 M HAc-NaAc buffer. The final concentration of the stock solution was then determined spectrophotometrically (Beckman DU 640 Specrophotoniieter) at 280 nm using A (1 (w/v, 1 cm)=26.3.

Analysis. Lysozyme is a well studied protein regarding solubility and crystallization in sodium acetate buffers, as a shift from net repulsive charges (highly positive B₂₂ value) to ideal net attractive charges (slightly negative B₂₂ value) occurs with 0% (w/v) to 5% (w/v) added sodium chloride. As a result of this well understood trend, lysozyme samples dissolved in 0.1 M NaAc buffer (pH 4.2) with 0%, 2%, and 5% (w/v) added sodium chloride were tested with the optical apparatus 10 in an effort to replicate well known B₂₂ values.

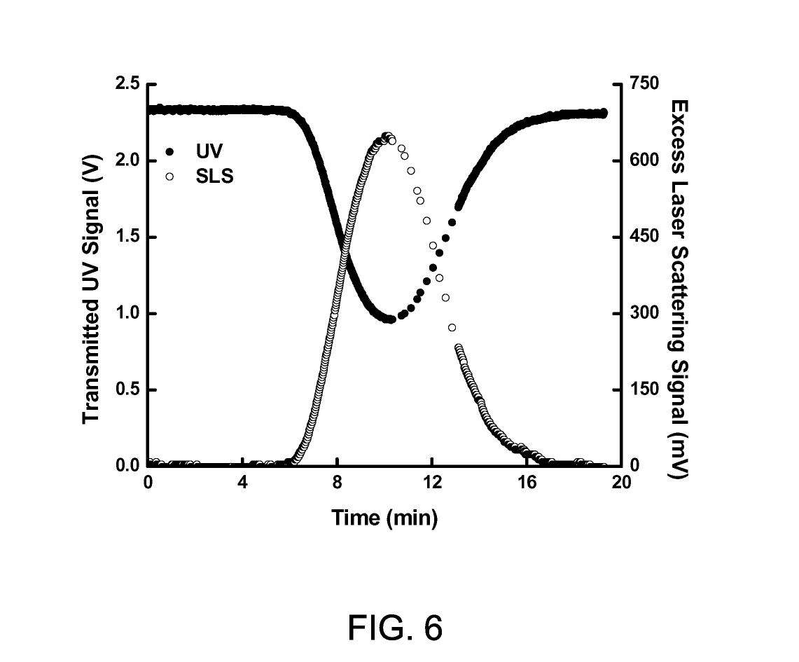

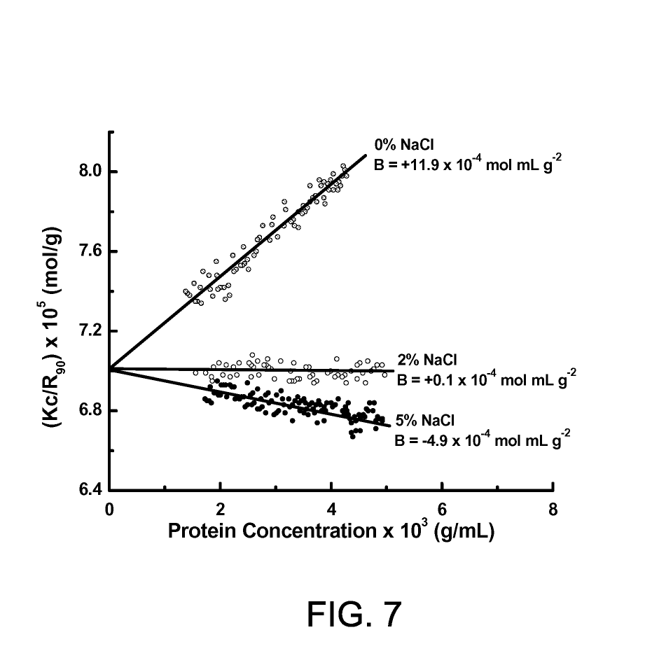

FIG. 6 represents the time trace of both the transmittance and light scattering signals from a nominal 6 mg/mL lysozyme solution evaluated at a flow rate of 1 μL/min. A portion of the tailing edge on each trace is presented with every fourth data point for visual clarity of transmittance (concentration) and light scattering point alignment. Once the transmittance values were converted to concentration values, the paired points were used to construct the Debye plots shown in FIG. 7. As expected, the 5% (w/v) sodium chloride solution resulted in a B₂₂ value of −4.9×10⁻⁴ mol mL g⁻², which compares favorably with the known net attractive forces between lysozyme molecules in this solvent condition (conventional B₂₂ value=−5.2×10⁻⁴ mol mL g⁻². In addition, evaluation of the Debye plots for the 0% (w/v) and 2% (w/v) NaCl buffers resulted in B₂₂ values of +11.9×10⁻⁴ mol mL g⁻² and +0.1×10⁻⁴ mol mL g⁻², respectively. Both of these results compared well with the known respective B₂₂ values of +12.1×10⁻⁴ mol mL g⁻² and +0.0×10⁻⁴ mol mL g⁻², which are both outside of the crystallization slot. These results thereby illustrated the capability of the optical apparatus 10 to accurately identify protein/solvent pairs that fall within the crystallization slot, using only micrograms of protein.

### EXAMPLE 2

Solutions and Sample Preparation. A 0.1 M HEPES buffer with 100 μM calcium chloride was prepared by dissolving 0.12 g of 4-(2-Hydroxyethyl)-1-Piperazineethanesulfonic acid and 0.55 ing of calcium chloride in approximately 40 mL of distilled/deionized water. The solution pH was adjusted to 7.8 by titrating with 1 M NaOH and then diluted to 50 mL with distilled/deionized water. Concanavalin A samples were prepared by slowly dissolving (without agitation) the protein into the HEPES buffer. The final concentration of the stock solution was then determined spectrophotometrically (Beckman DU 640 Spectrophotometer) at 280 nm using, A (1% (w/v), 1 cm)=13.0.

Analysis. The capability of the optical apparatus 10 to accurately measure the second virial coefficient for lysozyme in three different buffer systems served as a convincing set of proof of concept experiments. However, lysozyme represents the smaller scale of proteins to be evaluated with this system. Therefore, to demonstrate the wide range of applicability of the optical apparatus 10, the well characterized plant sugar-binding, protein Concanavalin A. (tetramer of molecular weight 104,000 Da) was evaluated in a non traditional HEPES buffer using both the optical apparatus 10 and the BM/SLS techniques. The light scattering values for Concanavalin A using the BM!SLS approach were 2500, 3380, 4300, 5170, and 6060 mV respectively for 0.9, 1.4, 1.9, 2.3 and 2.7 mg/mL solutions. The resulting c/I values were used to calculate a B₂₂ value of +2.4×10⁻⁴ mol mL g⁻², with an additional run resulting in a value of +1.9×10⁻⁴ mol mL g⁻². Proper pairing of the concentration and light scattering intensities measured with the optical apparatus 10 (max concentration of approximately 2.6 mg/mL detected) resulted in an average B₂₂ value of +2.2×10⁻⁴ mol mL g⁻² (n=2). The excellent agreement between the Debye plots (and corresponding B₂₂ values) illustrates the wide range of applicability of the optical apparatus 10 for evaluating higher molecular weight proteins in non traditional solvents.

### EXAMPLE 3

Solutions and Sample Preparation. Chloride, acetate, malonate, and citrate buffers were prepared at The University of Alabama at Birmingham and contained unknown concentrations/combinations of additives such as glycerol, calcium chloride, poly ethylene glycol, and argininie. The final concentration of each stock solution was determined spectrophotometrically (Beckman DU 640 Spectrophotometer) at 280 nm using A. (1% (w/v), 1 cm)=5.4. All buffer solutions were stored at room temperature and used within a two month period of the preparation date while all stock protein solutions were used within twenty four hours of preparationi. In addition, all buffer and sample solutions were manually filtered through a 0.2 μm Anotop 10 inorganic membrane filter (Whatman, Florham Park, N.J.) before use.

Analysis. ESA was dissolved in several solvent conditions (containing polyethylene glycol, glycerol, etc . . . ) hat were then screened for the crystallization slot. This set of experiments was designed to demonstrate the capability of the optical apparatus 10 to identify ideal crystallization solvents from a random batch of solution conditions, as well as highlight the minimal requirements regarding, protein mass.

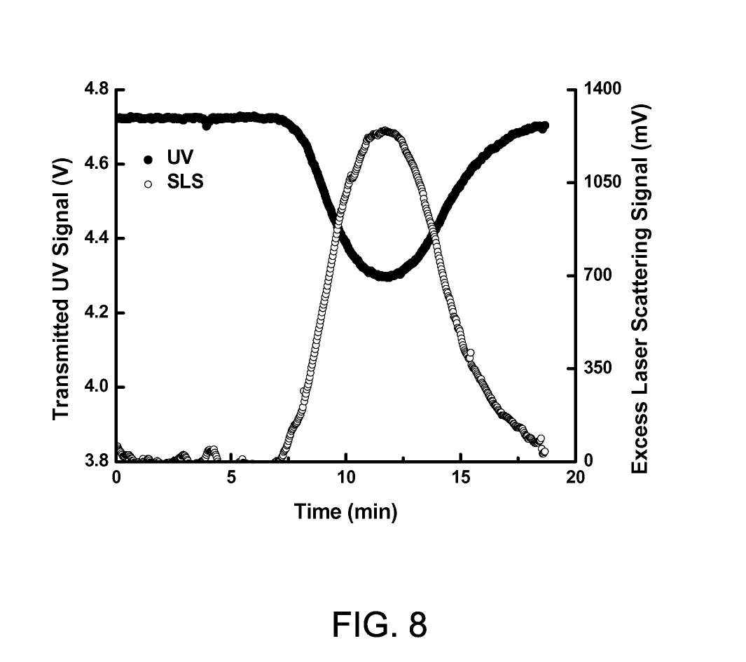

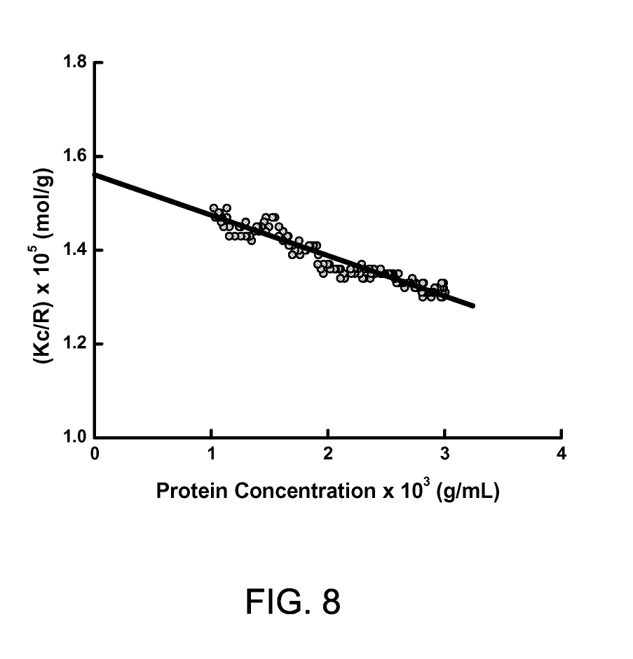

The B₂₂ values for eight unknown solvent conditions as determined by both the BM/SLS methodology and the optical apparatus 10 (sample time scan and Debye plot shown respectively in FIGS. 8 and 9) are shown in Table 1. As observed, both analysis methods identified solvents 3 and 7 as ideal conditions for the crystallization of ESA, with combined average B₂₂ values of −3.7×10⁻⁴ and −1.7×10⁻⁴ mol mL g⁻². In addition to the precision of the scale down measurement, this experimental set also illustrated the overall utility of the optical apparatus 10 in comparison to the BM/SLS approach. Each of the B₂₂ values obtained using, the BM/SLS method required approximately 750 μL of a nominal 10 mg/mL stock solution in order to obtain c/I vs c values for four different solution concentrations. Therefore, the BM/SLS analysis of one solvent condition required 7.5 mg of protein. In comparison, the optical apparatus 10 required only 30 μg of protein (5 μL of a nominal 6 mg/mL solution) for the complete analysis of a single solution condition. Therefore, screening, the eight solvent conditions (sixteen total runs) for the crystallization slot required 480 μg of protein using the optical apparatus 10 while the BM/SLS approach. needed 120 mg of protein. Considering, the total mass of protein used for the BM/SLS screen, 4000 runs could have been accomplished with the same amount of protein using the optical apparatus 10.

TABLE 1
CALCULATED SECOND VIRIAL COEFFICIENT VALUES
FOR ESA IN SEVERAL SOLVENT CONDITIONS

| | | |
|---|---|---|
| | Conventional | Scale down |
| Solvent # | (×10⁻⁴ mol mL g-2 | (×10⁻⁴ mol mL g-2) |

| | | | | |
|---|---|---|---|---|
| 1 | *2.0 | (n = 1) | 2.0 ± 1.4 | (n = 2) |
| 2 | 7.0 ± 1.4 | (n = 2) | 5.3 ± 1.5 | (n = 3) |
| 3 | −4.5 ± 0.7 | (n = 2) | −3.0 ± 1.0 | (n = 3) |
| 4 | 3.7 ± 1.2 | (n = 3) | *5.0 | (n = 1) |
| 5 | 4.5 ± 0.7 | (n = 2) | 2.5 ± 0.7 | (n = 2) |
| 6 | 1.0 ± 0 | (n = 3) | *3.0 | (n = 1) |
| 7 | *−1.0 | (n = 1) | −2.5 ± 0 | (n = 2) |
| 8 | 0 ± 1.4 | (n = 2) | −0.5 ± 0.7 | (n = 2) |

n equals the specified number of trials for each solvent while the *B₂₂ values represent a single trial, for which experimental accuracies could not be interpreted.

### EXAMPLE 4

Solution and Sample Preparation. The 1.25 M ammonium sulfate run buffer used in the optical apparatus 10 was prepared by mixing 1.28 L of 50 mM sodium acetate solution (pH 4.25) with 0.92 L of the stock 3.0 M ammonium sulfate buffer. Protein samples were prepared by initially dissolving approximately 2 mg of the appropriate protein in 150 μL of the stock 50 mM sodium acetate (pH 4.25) buffer. This sample was thoroughly agitated, and then allowed to equilibrate for at least 12 hours. The solution was centrifuged and 115 μL or the supernatant was slowly mixed with 85 μL of the stock 3.0 M ammonium sulfate buffer. The resulting solution was again centrifuged, with the supernatant evaluated using the optical apparatus 10. The final concentration of the stock protein solutions was not determined as a separate spectrophotometric experiment, but rather calculated online with the optical apparatus 10 at 280 nm using A (1% (w/v), 1 cm)=11.1 All stock buffer solutions were stored at room temperature and used within one month of the preparation date while all prepared buffer and protein solutions were used within eight hours of preparation. In addition, all buffer and sample solutions were manually filtered through a 0.2 μm Aniotop 10 inorganic membrane filter (Whatman, Florham Park, N.J.) before use.

Analysis. The specific function of proteins is dependent upon the amino acid sequence of the polypeptide chain., which ultimately determines the three dimensional folds of the molecule. Modifications in the amino acid sequence thereby change the folding pattern of the protein, and consequently affect tile structure, function, and stability of the modified molecule. This phenomenon has been the focus of molecular engineering, efforts aimed at site directed mutations in the amino acid sequence to study the folding characteristics of proteins under different conditions, which can provide information necessary to develop ideal pharmaceutical formulations. The Ribonucleases are one class of enzymes commonly used as a model system for protein folding studies as they have approximately 100 amino acid residues and a well understood globular structure. Ribonuclease Sa (molecular weight of 10,575 Da), a secretory ribonuclease from Streptomyces aureofaciens, has been modified to study the changes in folding characteristics as a function of protein solubility. Based on the well established correlation between the second virial coefficient (B₂₂) and the solubility of proteins in aqueous solution, the optical apparatus was used to measure B₂₂ of the wild-type and two variants of ribonuclease Sa.

The B₂₂ values, as measured with the optical apparatus 10, for the V2N, Q77F, and the wild-type ribonuclease Sa solutions were respectively +21.7±2.5×10⁻⁴ mol mL g⁻² (n=4), +6.9±1.5×10⁻⁴ mol mL g⁻² (n=2), and +15.2±2.0×10⁻⁴ mol mL g⁻² (n=4). The general trend of the B₂₂ values correlates well with experimentally obtained solubility data. The V2N variant has been shown to have an increased solubility in the ammonium sulfate buffer (14.54 mg/mL; wildtype, 10.79 mg/mL), which corresponds well with the more positive B₂₂ value (as compared to the wild-type molecule). On the other hand, the B₂₂ value for the Q77F variant is less positive than the value measured for the wild-type protein, and thereby correlates well with the known decreased solubility (6.05 mg/mL; wildtype, 10.79 mg/mL) of the Q77F molecule in comparison to the native molecule. These results indicate the potential of the optical apparatus 10 as an alternative means to estimate the effect of protein modifications as a function of solubility. In addition, this application of the optical apparatus 10 could also find utility in the area of surface mutagenesis as related to the enhancement of protein crystallization.

This discussion and the description are presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the (general principles defined herein may be applied to other embodiments and applications without departing from the scope of the invention. The present invention is not intended to be limited to the embodiments shown, but is to be accorded the widest possible scope consistent with the principles and features disclosed herein.

1. An apparatus comprising:
a) a flow cell comprising at least one inlet and at least one outlet;
b) a first source of electromagnetic radiation;
c) a second source of electromagnetic radiation;
d) a bifurcated optical fiber having a first end comprising first and second arms, with the first arm optically coupled to the first source of electromagnetic radiation and the second arm optically coupled to the second source of electromagnetic radiation, and a second end which transmits the electromagnetic radiation from both the first and second sources into the flow through cell to produce a concentration signal and a light scattering signal;
e) at least one means for measuring the concentration signal; and
f) at least one means for measuring the light scattering signal.

2. The apparatus of claim 1 further comprising a computing means for calculating the macromolecular solution properties from the concentration signal and the light scattering , signal.

3. The apparatus according to claim 1, further comprising a lens which focuses the electromagnetic radiation from the second end of the bifurcated optical fiber into the flow through cell.

4. The apparatus according to claim 1, further comprising a lens which focuses the light scattering signal onto the means for measuring the light scattering, signal.

5. The apparatus according to claim 1, further comprising a lens which focuses the concentration signal onto the means for measuring the concentration signal.

6. The apparatus according to claim 1, further comprising a filter optically connected to the means for measuring the concentration signal.

7. The apparatus according to claim 1, further comprising a sample delivery system for introducing a macromolecular solution into the flow cell.

8. The apparatus according to claim 1, further comprising an optical fiber optically connected to the means for measuring the light scattering signal.

9. The apparatus according to claim 1 wherein the first source of electromagnetic radiation is selected from the group consisting of ultraviolet, ultraviolet-visible, infrared, visible, and near infrared lamps.

10. The apparatus according to claim 1 wherein the second source of electromagnetic radiation is selected from the group consisting of ultraviolet, ultraviolet-visible, infrared, visible, and near infrared lamps.

11. The apparatus according to claim 1 wherein the bifurcated fiber can be selected from the group consisting of single mode and multimode fibers and combinations thereof.

12. The apparatus according to claim 1 wherein the means for measuring the concentration signal is selected from the group consisting of ultraviolet, ultraviolet-visible, infrared, visible, and near infrared detectors.

13. The apparatus according to claim 1 wherein the means for measuring the light scattering signal is selected from the group consisting of ultraviolet, ultraviolet-visible, infrared, visible, and near infrared detectors.

14. A method of calculating the second virial coefficient of a macromolecular solution, comprising:
a) introducing a flowing, macromolecular solution into a flow cell;
b) directing electromagnetic radiation from two sources through a bifurcated optical fiber to the macromolecular solution in the flow cell to generate a concentration signal and a light scattering signal;
c) measuring the concentration signal and the light scattering signal;
d) storing the concentration signal and light scattering signal at pre-selected time intervals;
e) calculating, a signal ratio for each pre-selected time interval concentration signal/light scattering signal;
f) constructing, a data plot of the signal ratio vs. the concentration signal;
g) calculating, the slope and y-intercept of the data plot; and
h) calculating, the second virial coefficient of the macromolecular solution.

15. The method. of claim 14 wherein said second virial coefficient correlates with properties of the macromolecular solution.
